(19) United States
(12) Patent Application Publication
(10) Pub. No.: US 2019/0026080 A1
(43) Pub. Date: Jan. 24, 2019

(54) METHOD FOR DYNAMICALLY EXPANDING A DOMAIN-SPECIFIC LANGUAGE OF A GRAPHICAL MODELING TOOL

(71) Applicant: Siemens Aktiengesellschaft, Munchen (DE)

(72) Inventors: Sieglinde Kranz, Germering (DE); Stephan Storck, Bad Feilnbach - Au (DE); Nikolaus Regnat, München (DE)

(21) Appl. No.: 16/040,622

(22) Filed: Jul. 20, 2018

(30) Foreign Application Priority Data
Jul. 21, 2017 (DE) 102017212581.0

(51) Int. Cl. G06F 8/20

(52) U.S. Cl. CPC G06F 8/20

(57) ABSTRACT

A method for dynamically expanding a domain-specific language of a graphical modeling tool for generating a model of a technical system, wherein the model is described in the domain- specific language by means of elements and their relationships taking into account properties and can be graphically visualized on an output unit. The method includes providing a language definition for each element and each relationship of the domain-specific language, wherein each element is assigned a type and a number of properties, providing at least one placeholder in the language definition for a user-defined language element, and providing a user interface which is configured to be used by a user to define the user-defined language element.

### CROSS-REFERENCE TO RELATED APPLICATIONS

This application claims priority to German application No. 102017212581.0 having a filing date of Jul. 21, 2017, the entire contents of which are hereby incorporated by reference.

### FIELD OF TECHNOLOGY

The following relates to a method for dynamically expanding a domain-specific language of a graphical modeling tool for generating a model of a technical system. The technical system is described in the domain-specific language by means of elements and their relationships taking into account properties and can be graphically visualized on an output unit.

### BACKGROUND

In the present description, a technical system is understood as meaning a hardware system, a software system, a mechanical system, an electrical system or an electromechanical system. A technical system can generally be understood as meaning any system comprising hardware and/or software components.

Such a technical system can be described by an architecture specification which describes the technical system by means of elements and their relationships taking into account properties. Elements can be understood as meaning units (for example electrical and/or mechanical units), components (for example an electrical drive) or subsystems (for example a drive system having a plurality of drive motors).

The relationships take into account the interaction between the elements from a mechanical and/or electrical and/or pneumatic point of view or in another manner. This is carried out with the aid of properties, for example attributes, restrictions, quality features or design guidelines. On the basis of the architecture specification, it is possible to generate interpretable graphical representations of the technical system, on the basis of which the technical system can be created and/or maintained.

The model-based architecture development requires the provision of a language definition for each element and each relationship of the domain-specific language. This definition is created by experts. However, a user of the graphical modeling tool, for example MagicDraw, is faced with the problem that he cannot make any changes whatsoever to the domain-specific language on account of the complexity. As a result, the use of the modeling tool sometimes becomes cumbersome since, when designing a technical system, the situation can arise in which further elements or further properties have to be taken into account. However, consideration in the modeling tool is possible only by the expert in the domain-specific language, which is cumbersome and time-consuming.

### SUMMARY

An aspect relates to specifying a method and a system for dynamically expanding a domain-specific language of a graphical modeling tool which avoid the problem described above. In particular, the dynamic expansion of the domain-specific language is intended to facilitate the usability of the graphical modeling tool.

These objects are achieved by means of a method according to the features of patent claim 1 and a system according to the features of patent claim 10. Advantageous configurations emerge from the dependent patent claims.

A method for dynamically expanding a domain-specific language of a graphical modeling tool for generating a model of a technical system is proposed. The model is described in the domain-specific language by means of elements and their relationships taking into account properties and can be graphically visualized on an output unit. The output unit may be, for example, the screen of a computer (laptop, stationary computer and the like) or of a tablet PC.

The method comprises the steps of providing a language definition for each element and each relationship of the domain-specific language, wherein each element is assigned a type and a number of properties. The step of providing the language definition for each element and each relationship is carried out by an expert in the domain-specific language for the graphical modeling tool used. The step of providing the language definition is carried out once. As part of the process of providing the language definition, definitions are generated for all possible elements and relationships of the domain-specific language. In a further step, at least one placeholder is provided in the language definition for a user-defined language element. A user interface which can be used by a user to define the user-defined language element is also provided.

This method makes it possible to expand the domain-specific language in a simple and dynamic manner without an expert in the domain-specific language being required for the expansion. The expansion is facilitated by virtue of the fact that at least one placeholder is provided in the language definition for a user-defined language element. This placeholder can then be assigned contents by a user via the user interface provided during use of the graphical modeling tool. This makes it possible, for example, for a user to “subsequently” add a missing definition of an element or of a relationship or of a property during use of the modeling tool.

The method allows particular adaptations of the domain-specific language to be dynamically carried out by the user. In particular, the user does not require any knowledge whatsoever of the creation or the adaptation of the language definition of the domain-specific language. Rather, the user can carry this out using the possibilities of the modeling tool which are known to him. This results in a considerable saving in terms of time and costs when using the graphical modeling tool.

As a result of the method, the modeling tool can be adapted, for example by means of an expansion (so-called plug-in), in such a manner that a user can himself carry out particular adaptations. In this case, the possibilities of describing domain-specific languages and the associated visualization are adapted and used.

The type of user-defined language element can expediently be determined by the user. The user-defined language element may be an element of the domain-specific language. This makes it possible, for example, to define further units, components or subsystems. The user-defined language element may also be a relationship of the user-defined language. This makes it possible to newly generate a relationship between two elements which has previously not been taken into account.

It is also expedient if the user-defined language element is a property of the domain-specific language, in particular a property of a respective element or of a respective relationship. This makes it possible, in particular, to modify the visualization of the model with regard to properties, for example the size of an element and/or the shape of an element and/or the color of an element or of a relationship and/or the line type and the like.

It is also expedient if user-defined changes to the language element are automatically processed by the graphical modeling tool and result in an updated visualization on the output unit. This simplifies the handling of the modeling tool since changes made by a user are no longer carried out manually, but rather automatically.

According to another configuration, a plug-in of the graphical modeling tool can be used as a user interface. The user interface is therefore provided in an expansion of the modeling tool which is coupled to the modeling tool via a communication channel for this purpose. The practice of providing the user interface in an expansion entails the advantage that the method according to embodiments of the invention can be used almost with any modeling tool available on the market.

It is also expedient if the user-defined language elements are language elements defined in the domain-specific language or new language elements.

Embodiments of the invention also propose a computer program product (non-transitory computer readable storage medium having instructions, which when executed by a processor, perform actions)” which can be directly maintained in the internal memory of a digital computer and comprises software code sections which are used to carry out the steps of the method described here when the product runs on the computer. The computer program product may be in the form of a DVD, a CD-ROM, a USB stick or another non-volatile memory. The computer program product can also be in the form of a data signal which can be loaded wirelessly or in a wired manner via a network.

Embodiments of the invention also propose a system for dynamically expanding a domain-specific language of a graphical modeling tool for generating a model of a technical system which is described in the domain-specific language by means of elements and their relationships taking into account properties and can be graphically visualized on an output unit. The system comprises first means for providing a language definition for each element and each relationship of the domain-specific language, wherein each element is assigned a type and a number of properties. The system comprises second means for providing at least one placeholder in the language definition for a user-defined language element. Finally, the system comprises third means for providing a user interface which can be used by a user to define the user-defined language element.

The proposed system has the same advantages as explained above in connection with the method according to embodiments of the invention.

In addition, the system may comprise further means for carrying out the method according to embodiments of the invention, as described in the present description.

### BRIEF DESCRIPTION

:Some of the embodiments will be described in detail, with reference to the following figures, wherein like designations denote like members, wherein:

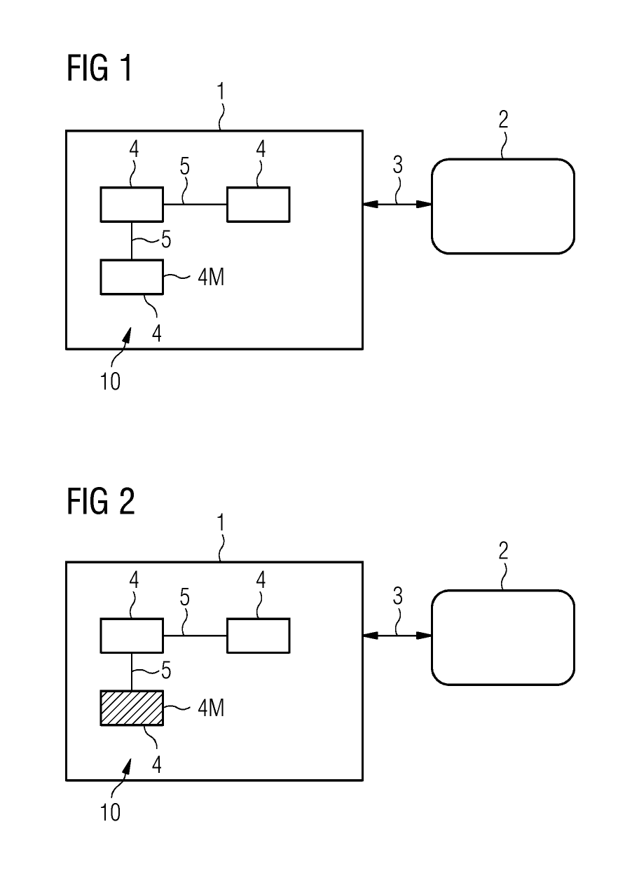

FIG. 1 shows a schematic illustration of a model of a technical system, which is visualized and generated with the aid of a modeling tool, together with an expansion according to embodiments of the invention for dynamically expanding a domain-specific language of the modeling tool; and

FIG. 2 shows the schematic illustration from FIG. 1 with a changed visualization of the model of the technical system on account of a changed definition of a language element.

### DETAILED DESCRIPTION

FIGS. 1 and 2 show a graphical modeling tool 1 which is provided with an expansion 2 (so-called plug-in). The modeling tool 1 may be a domain-specific modeling tool. General modeling tools, for example the MagicDraw software, are also possible. With the aid of the modeling tool 1, it is possible to visualize a model of a technical system on an output unit which is not illustrated in any more detail in the figures. In this case, the technical system is described in a formal, in particular graphical, modeling language used by the modeling tool by means of elements 4 and their relationships 5 taking into account properties.

Such a visualization of a model of a technical system is schematically indicated in FIGS. 1 and 2 with the reference sign 10. The illustrated model comprises, by way of example, three elements 4 which are each illustrated by rectangles. The elements 4 are connected to one another by means of two relationships 5, again only by way of example. The relationships 4 are represented by lines connecting two elements 4 in each case.

A respective element 4 represents, for example, an electrical, mechanical or pneumatic unit, a component (for example an electrical drive) or a subsystem (for example a drive system having a plurality of drive motors) of the model. The relationships 5 between two elements 4 take into account the interaction between the elements from a mechanical or electrical or pneumatic or other point of view. In addition, further properties, for example attributes, restrictions, quality features or design guidelines, can be visualized by means of the modeling tool 1. These are not illustrated in FIG. 1 for the sake of simplicity.

The modeling tool 1 is provided with an expansion 2. The expansion 2 is able to communicate with the modeling tool 1 via a communication channel 3 in order to read data from the modeling tool 1 or to write data to the latter.

The task of the expansion 2 is to provide the user of the modeling tool with the possibility of expanding the existing domain-specific language to a certain extent without requiring an expert in language definitions for this purpose.

Language definitions are defined for each element 4 and for each relationship 5 in the domain-specific language of the modeling tool 1 by the expert in the domain-specific language. As a result, each element 4 is assigned a type (for example mechanical element or electrical element) and a number of properties (for example shape, color and size for the visualization). The definition and the assignment are initially carried out by the expert in the domain-specific language. The language definition is neither accessible to the user during conventional operation of the modeling tool 1 nor can be modified by the user on account of its complexity.

In order to make it possible for the user of the modeling tool 1 to create special elements, for example a new type, and to stipulate a desired visualization with the aid of the properties thereof, placeholders for a user-defined language element are provided in the language definition. Language elements can be defined by a user via the expansion 2 as a user interface. In particular, the type of user-defined language element can be determined by the user. For example, new elements and/or relationships and/or properties can be added or existing elements and/or relationships and/or properties can be changed in a predefined manner. The expansion makes it possible for the user to also link existing elements 4, that is to say elements predefined in the language definition, to the new elements. The expansion 2 detects such changes and adapts the visualization 10 according to the changed language definition.

This can be seen, by way of example, in FIGS. 1 and 2, wherein the visualization 10 in the illustration in FIG. 2 differs from the visualization 10 in the illustration in FIG. 1 in the element 4M. Via the expansion 2, the user has changed the properties for representing the visualization in such a manner that the filling area is no longer monochromatic, but rather has oblique hatching. This changed visualization may be a result of the definition of a changed type of element, for example.

The expansion makes it possible to carry out adaptations to the domain-specific language, wherein these adaptations do not have to be statically implemented by an expert in the domain-specific language. The user does not require any knowledge whatsoever of the creation or the adaptation of the language definition of the domain-specific language. Rather, user-defined language elements can be adapted or generated using simple means of an interface of the expansion 2. This results in a considerable saving in terms of time and costs, for example if new elements or new element types have to be defined.

As a result, the expansion 2, which constitutes an additional software component to the modeling tool 1, makes it possible to adapt the modeling tool such that the user can himself carry out particular adaptations. In this case, possibilities of describing domain-specific language and the associated visualization are newly defined and processed in a simple manner which can be used by the user.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for dynamically expanding a domain-specific language of a graphical modeling tool for generating a model of a technical system, wherein the model is described in the domain-specific language by means of elements and their relationships taking into account properties and can be graphically visualized on an output unit, comprising the steps of:
a) providing a language definition for each element and each relationship of the domain-specific language, wherein each element is assigned a type and a number of properties;
b) providing at least one placeholder in the language definition for a user-defined language element; and
c) providing a user interface which is configured to be used by a user to define the user-defined language element.

2. The method as claimed in claim 1, in which the type of user-defined language element is configured to be determined by the user.

3. The method as claimed in claim 1, in which the user-defined language element is an element of the domain-specific language.

4. The method as claimed in claim 1, in which the user-defined language element is a relationship of the domain-specific language.

5. The method as claimed in claim 1, in which the user-defined language element is a property of the domain-specific language.

6. The method as claimed in claim 1, in which user-defined changes to the language element are automatically processed by the graphical modeling tool and result in an updated visualization on the output unit.

7. The method as claimed in claim 1, in which a plug-in of the graphical modeling tool is used as a user interface.

8. The method as claimed in claim 1, in which the user-defined language elements are language elements defined in the domain-specific language or new language elements.

9. A computer program product comprising a computer readable hardware storage device having computer readable program code stored therein, said program code executable by a processor of a computer system to implement a method as claimed in claim 1.

10. A system for dynamically expanding a domain-specific language of a graphical modeling tool for generating a model of a technical system which is described in the domain-specific language by means of elements and their relationships taking into account properties and can be graphically visualized on an output unit, comprising:
a) a first means for providing a language definition for each element and each relationship of the domain-specific language, wherein each element is assigned a type and a number of properties;
b) a second means for providing at least one placeholder in the language definition for a user-defined language element; and
c) a third means for providing a user interface which is configured to be used by a user to define the user-defined language element.

11. The method as claimed in claim 1, in which the user-defined language element is a property of a respective element or of a respective relationship.
